(19) United States
(12) Patent Application Publication
(10) Pub. No.: US 2009/0101235 A1
(43) Pub. Date: Apr. 23, 2009

(54) FEEDING MECHANISM FOR A WOODWORKING MACHINE

(76) Inventor: Chin-Chi Lin, Houli Township (TW)

Correspondence Address: OCCHIUTI ROHLICEK & TSAO, LLP, 10 FAWCETT STREET, CAMBRIDGE, MA, 02138, US

(21) Appl. No.: 12/123,149

(22) Filed: May 19, 2008

(30) Foreign Application Priority Data
Oct. 17, 2007 (TW) 096138871

(51) Int. Cl. B27C 1/12

(52) U.S. Cl. 144/245.1

(57) ABSTRACT

A feeding mechanism adapted for use with a woodworking machine includes a driving unit and a feeding roller unit. The feeding roller unit includes a driven shaft that extends along an axis from the driving unit and that is driven by the driving unit to rotate about the axis, a feeding roller that is disposed co-rotatably around the driven shaft, a plurality of contact components, and a plurality of resilient components. Each of the contact components has a contact end portion and is resiliently movable relative to the feeding roller between an extended position, where the contact end portion is exposed from the feeding roller, and a retracted position, where the contact end portion is retracted into the feeding roller. Each of the resilient components is disposed for biasing a respective one of the contact components toward the extended position.

### CROSS-REFERENCE TO RELATED APPLICATION

This application claims priority of Taiwanese Application No. 096138871, filed on Oct. 17, 2007.

### BACKGROUND OF THE INVENTION

1. Field of the Invention

The invention relates to a feeding mechanism, more particularly to a feeding mechanism for a woodworking machine.

2. Description of the Related Art

A woodworking machine generally has a feeding mechanism for feeding a workpiece on the woodworking machine. A conventional feeding mechanism is disposed to be in frictional contact with the workpiece. However, when the workpiece has an irregular thickness, the pressure applied on the workpiece by the feeding mechanism is uneven, such that the workpiece cannot be fed smoothly. Additionally, the irregular thickness of the workpiece may cause vibration of the conventional feeding mechanism during the feeding process, thereby resulting in a relatively short service life of the woodworking machine.

U.S. Pat. No. 6,705,455 B2 discloses a feeding roller for a woodworking machine. Referring to FIG. 1, the feeding roller includes a driven shaft 1, a hub member 2 disposed co-rotatably around the driven shaft 1, a workpiece contacting member 3 disposed to surround the hub member 2, and a plurality of angularly spaced apart connecting components 4 disposed between the hub member 2 and the workpiece contacting member 3. The hub member 2 has a plurality of angularly spaced apart anchored seat portions 201, each of which extends radially and outwardly relative to the driven shaft 1. The workpiece contacting member 3 has a plurality of grooves 301 for receiving respectively the anchored seat portions 201, and a plurality of driven portions 302, each of which is disposed in a respective one of the grooves 301 at a position corresponding to a respective one of the anchored seat portions 201. Each of the connecting components 4 is a compression spring disposed between a respective one of the anchored seat portions 201 and the corresponding one of the driven portions 302. When a workpiece of an irregular thickness is fed by the feeding roller, the workpiece contacting member 3 can be biased to move relative to the hub member 2 by the connecting components 4, such that the workpiece can be fed smoothly. However, during the aforesaid biasing action of the workpiece contacting member 3, each of the connecting components 4 bears not only a longitudinal force for expanding or retracting in a longitudinal direction, but also a shear force in a lateral direction, thereby resulting in a relatively short service life of the feeding roller. Moreover, if the workpiece has a severely irregular thickness and is fed quickly, the workpiece contacting member 3 may be biased relative to the hub member 2 to flip too fastly to maintain in frictional contact with the workpiece during the feeding process.

### SUMMARY OF THE INVENTION

Therefore, the object of the present invention is to provide a feeding mechanism that can feed a workpiece smoothly and that is durable.

Accordingly, a feeding mechanism of the present invention is adapted for use with a woodworking machine and includes a driving unit and a feeding roller unit. The feeding roller unit includes a driven shaft that extends along a first axis from the driving unit and that is driven by the driving unit to rotate about the first axis, a feeding roller that is disposed co-rotatably around the driven shaft, a plurality of contact components, and a plurality of resilient components. Each of the contact components has a contact end portion and is resiliently movable relative to the feeding roller between an extended position, where the contact end portion is exposed from the feeding roller, and a retracted position, where the contact end portion is retracted into the feeding roller. Each of the resilient components is disposed for biasing a respective one of the contact components toward the extended position.

### BRIEF DESCRIPTION OF THE DRAWINGS

Other features and advantages of the present invention will become apparent in the following detailed description of the preferred embodiment with reference to the accompanying drawings, of which:

FIG. 1 is a side view of a conventional feeding mechanism for a woodworking machine;

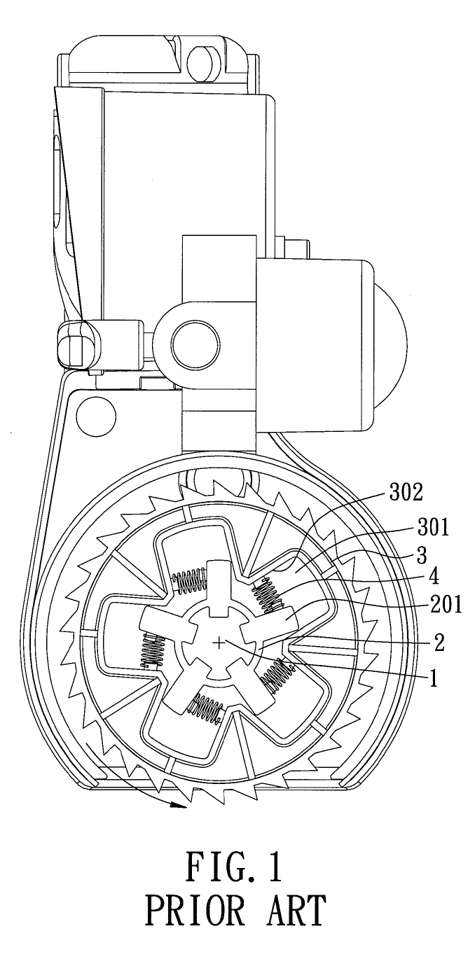

FIG. 2 is a side view of a preferred embodiment of a feeding mechanism for a woodworking machine according to the invention;

FIG. 3 is a perspective view of the preferred embodiment;

FIG. 4 is another perspective view of the preferred embodiment, illustrating a feeding roller in a housing;

FIG. 5 is a partly sectional view of the preferred embodiment;

FIG. 6 is a partly exploded perspective view of a feeding roller unit of the preferred embodiment;

FIG. 7 is a sectional view of the preferred embodiment taken along line VII-VII in FIG. 5; and

FIG. 8 is a view similar to FIG. 7, but illustrating the preferred embodiment while feeding a workpiece.

### DETAILED DESCRIPTION OF THE PREFERRED EMBODIMENT

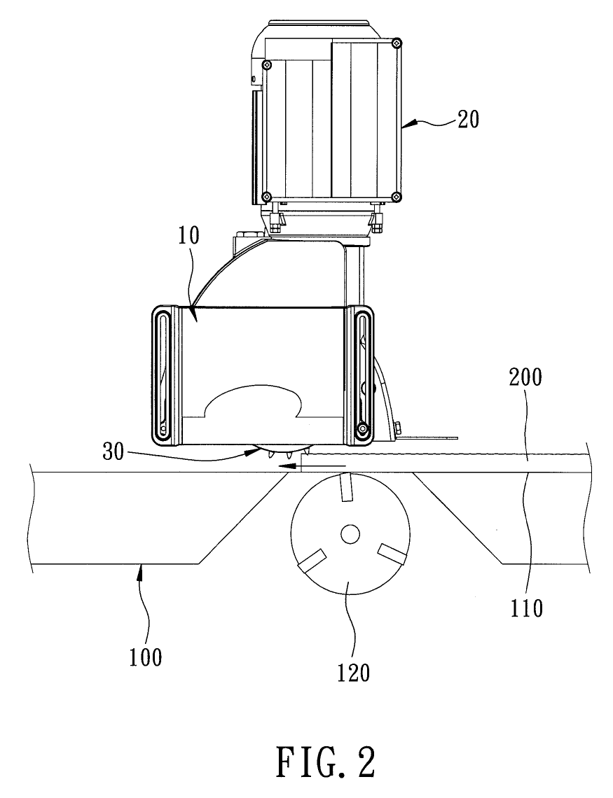

As shown in FIG. 2, the preferred embodiment of a feeding mechanism according to the present invention is adapted for mounting on a worktable 110 of a woodworking machine, such as a planer 100. A workpiece 200 is fed by the feeding mechanism, and is then planed smooth by a plane iron 120 of the planer 100. The feeding mechanism comprises a housing 10, a driving unit 20 disposed in the housing 10, and a feeding roller unit 30.

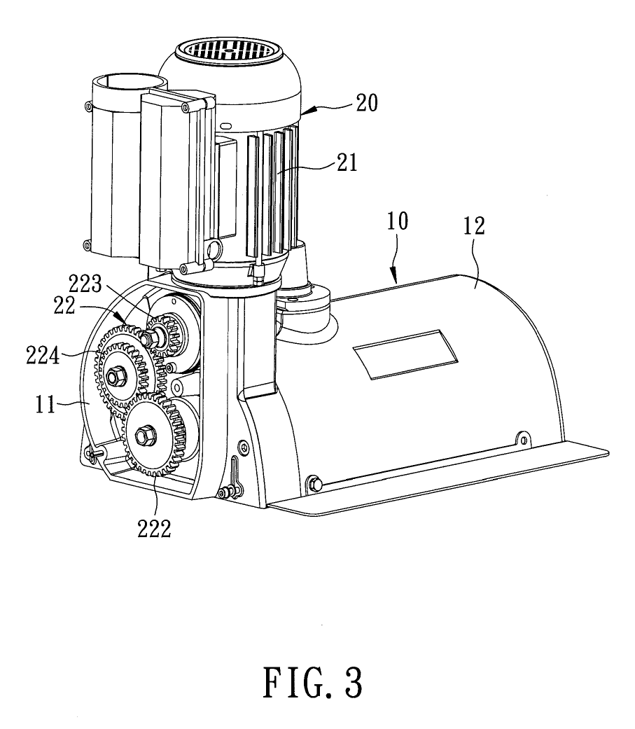

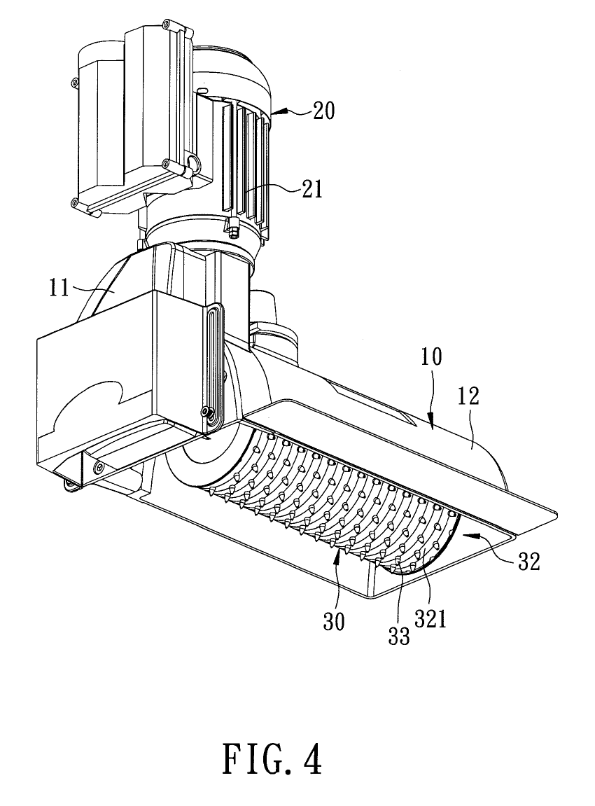

As shown in FIGS. 3 to 5, the housing 10 includes a hollow gear box 11 and a semicylindrical cover 12 connected to the gear box 11 at one end thereof.

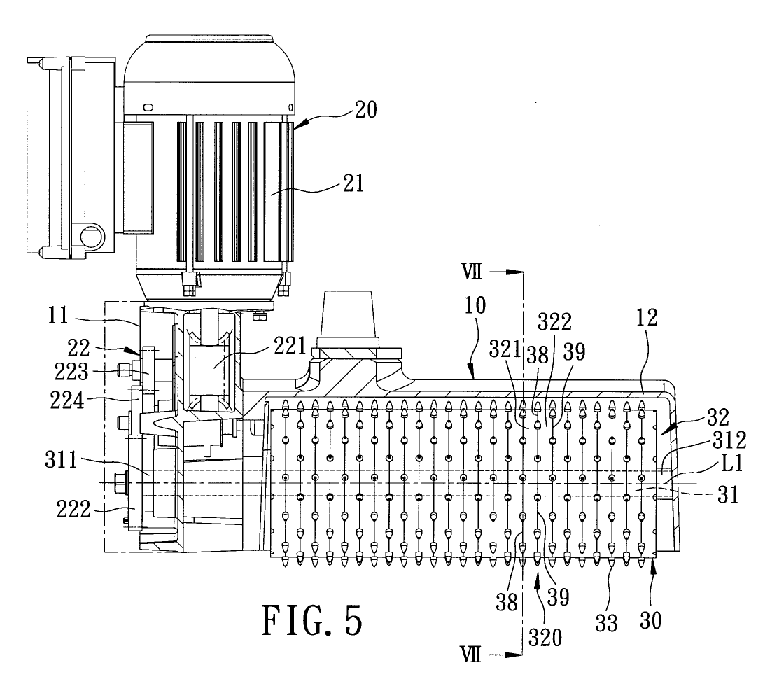

As shown in FIGS. 3 and 5, the driving unit 20 includes a motor 21 disposed on the gear box 11 of the housing 10, and a speed reduction gear unit 22 disposed in the housing 10. The speed reduction gear unit 22 includes a driver component 221 connected to the motor 21, a driven component 222, and first and second transmission components 223, 224 connected between the driver component 221 and the driven component 222. In this embodiment, the driver component 221 is a worm shaft, and the driven component 222 is a spur gear. The first transmission component 223 includes a worm gear meshing with the driver component 221, and a spur gear co-rotatable with the worm gear. The second transmission component 224 is a dual-stepped gear member meshing with the driven component 222 and the first transmission component 223.

As shown in FIGS. 5 to 7, the feeding roller unit 30 includes a driven shaft 31, a feeding roller 32, a plurality of contact components 33, a plurality of resilient components 34, and a plurality of self-lubricating bushing units 350.

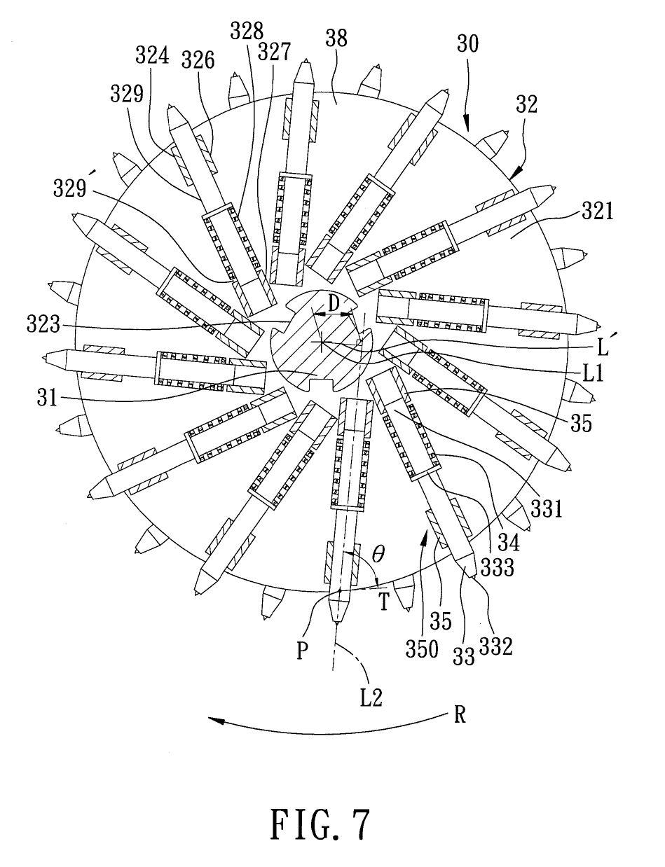

The driven shaft 31 is a spline shaft (see FIG. 7) that extends along a first axis (L1), that has opposite first and second ends 311, 312 along the first axis (L1), that is connected coaxially to the driven component 222 of the speed reduction gear unit 22 of the driving unit 20, and that is driven by the driving unit 20 to rotate about the first axis (L1).

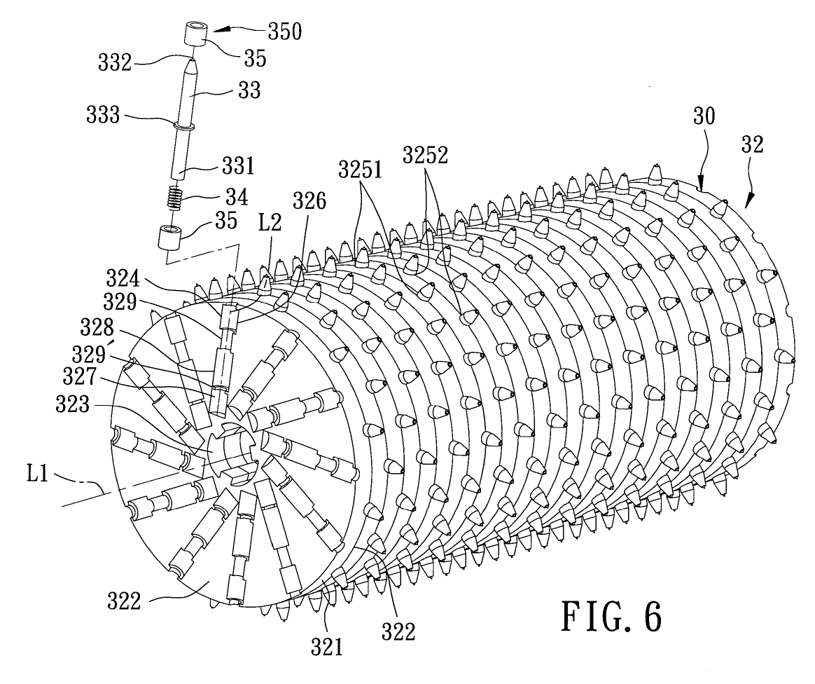

The feeding roller 32 is disposed co-rotatably around the driven shaft 31. In this embodiment, as shown in FIGS. 6 and 7, the feeding roller 32 rotates in a rotational direction (R), and includes a plurality of roller plate units 320 that are juxtaposed with each other along the first axis (L1). Each of the feeding roller plate units 320 has first and second roller plates 321, 322 that are respectively proximate to and distal from the first end 311 of the driven shaft 31. Each of the first and second roller plates 321, 322 has opposite first and second side surfaces 38, 39 along the first axis (L1), and a splined shaft hole 323 which extends through the first and second side surfaces 38, 39, and through which the driven shaft 31 extends. The second side surface 39 of the first roller plate 321 is in contact with the first side surface 38 of the second roller plate 322. Each of the second side surface 39 of the first roller plate 321 and the first side surface 38 of the second roller plate 322 is formed with a plurality of angularly spaced apart grooves 324. Each of the grooves 324 in the second side surface 39 of the first roller plate 321 cooperates with a respective one of the grooves 324 in the first side surface 38 of the second roller plate 322 to form a first receiving hole 3251 for confining movably a corresponding one of the contact components 33 therein. Additionally, the first side surface 38 of the first roller plate 321 of each of the roller plate units 320 is formed with a plurality of angularly spaced apart grooves 324, and the second side surface 39 of the second roller plate 322 of each of the roller plate units 320 is also formed with a plurality of angularly spaced apart grooves 324. Each of the grooves 324 in the second side surface 39 of the second roller plate 322 of each of the roller plate units 320 other than the rightmost one cooperates with a respective one of the grooves 324 in the first side surface 38 of the first roller plate 321 of an adjacent one of the roller plate units 320 to form a second receiving hole 3252 for confining movably a corresponding one of the contact components 33 therein. In this embodiment, the first receiving holes 3251 in each of the roller plate units 320 are staggered circumferentially relative to the second receiving holes 3252. Each of the first and second receiving holes 3251, 3252 has a first large diameter hole section 326 adjacent to the periphery of the corresponding one of the roller plate units 320, a second large diameter hole section 327 spaced apart from the first large diameter hole section 326 and formed adjacent to the driven shaft 31, an intermediate hole section 328 formed between the first and second large diameter hole sections 326, 327, a first small diameter hole section 329 formed between the first large diameter hole section 326 and the intermediate hole section 328, and a second small diameter hole section 329′ formed between the second large diameter hole section 327 and the intermediate hole section 328.

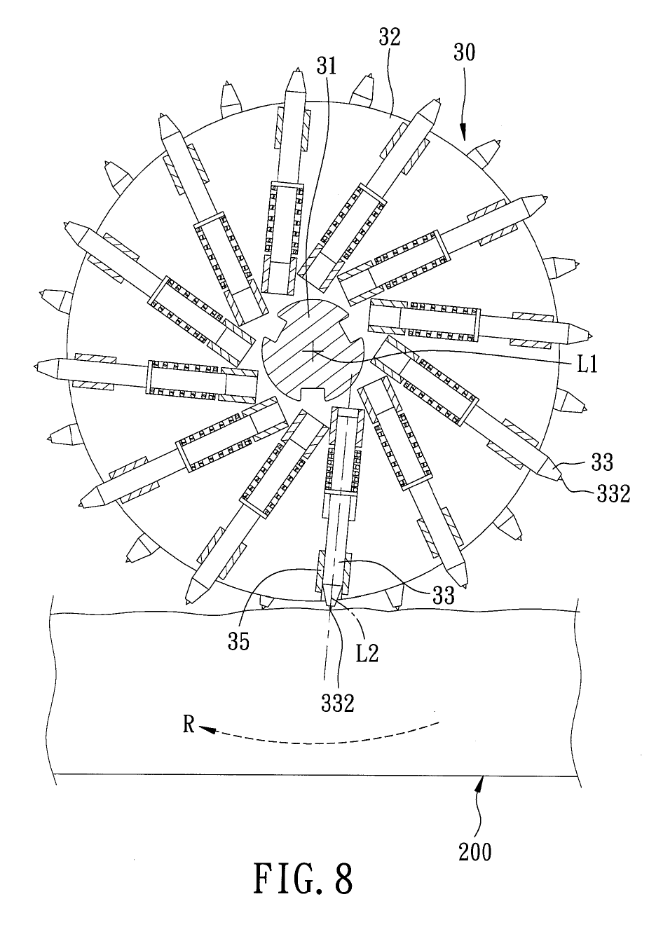

Each of the contact components 33 has a tapered contact end portion 332, an inner end portion 331 that is disposed opposite to the contact end portion 332 and that extends into the second large diameter hole section 327 of a respective one of the first and second receiving holes 3251, 3252, and a flange portion 333 that is disposed between the inner end portion 331 and the contact end portion 332, that is confined in the intermediate hole section 328 of the respective one of the first and second receiving holes 3251, 3252, and that permits a respective one of the resilient components 34 to abut resiliently thereagainst. Each of the contact components 33 is resiliently movable relative to the feeding roller 32 between an extended position (see FIG. 7), where the contact end portion 332 thereof is exposed from the feeding roller 32, and a retracted position (see FIG. 8), where the contact end portion 332 thereof is retracted into the feeding roller 32. Referring to FIG. 7, in this embodiment, each of the contact components 33 extends along a second axis (L2) that is spaced apart from the first axis (L1) by a predetermined distance (D) along an imaginary line (L′) passing through and perpendicular to the first and second axes (L1, L2). Preferably, the second axis (L2) along which each of the contact components 33 extends intersects a periphery of the corresponding one of the roller plate units 320 of the feeding roller 32 at an imaginary intersecting point (P), and forms an angle (θ) with an imaginary tangent line (T) at the imaginary intersecting point (P). In this embodiment, the angle (θ) is about 85 degrees.

Each of the resilient components 34 is a compression spring and is disposed in the intermediate hole section 328 of a respective one of the first and second receiving holes 3251, 3252 in the feeding roller 32. Each of the resilient components 34 has two opposite ends abutting respectively and resiliently against the flange portion 333 of a respective one of the contact components 33 and a shoulder defined by the intermediate hole section 328 and the second small diameter hole section 329′ of the respective one of the first and second receiving holes 3251, 3252 for biasing the respective one of the contact components 33 toward the extended position.

The self-lubricating bushing units 350 are disposed respectively in the first and second receiving holes 3251, 3252 in the roller plate units 320 of the feeding roller 32, and are sleeved respectively on the contact components 33 for lubricating the same during movement between the extended position and the retracted position. Each of the self-lubricating bushing units 350 includes a pair of self-lubricating bushes 35 disposed respectively within the first and second large diameter hole sections 326, 327 of the respective one of the first and second receiving holes 3251, 3252 and sleeved on the respective one of the contact components 33.

When the planer 100 is in use, the workpiece 200 is conveyed toward the feeding mechanism of the invention, and the driving unit 20 is actuated to drive rotation of the feeding roller 32 of the feeding roller unit 30 in the rotational direction (R). As shown in FIG. 8, the rotation of the feeding roller 32 results in frictional contact between the contact end portions 332 of the contact components 33 and the workpiece 200, thereby moving the workpiece 200 cut of the feeding mechanism. If the contacted portion of the workpiece 200 has a dent, each of the corresponding contact components 33 will be biased toward the extended position during contact with the workpiece 200. Contrarily, if the contacted portion of the workpiece 200 has a protrusion, each of the corresponding contact components 33 will be biased toward the retracted position during contact with the workpiece 200. Since the contact components 33 are movable independently of each other, and are disposed respectively in the first and second receiving holes 3251, 3252 in the feeding roller 32, the feeding mechanism of the invention can maintain smooth contact with the workpiece 200 during the feeding process even if the workpiece 200 has an irregular thickness. Additionally, during the resilient movement of the contact components 33, each of the resilient components 34 bears only a longitudinal force for expanding or retracting along the second axis (L2), thereby resulting in a longer service life of the feeding mechanism than the prior art. Moreover, the circumferentially staggered arrangement of the first and second receiving holes 3251, 3252 creates more contact points of the feeding roller 32 with the workpiece 200 in the circumferential direction of the feeding roller 32 at a time, such that the workpiece 200 can be fed more smoothly by the feeding mechanism of the invention. Furthermore, since each of the first and second receiving holes 3251, 3252 and the contacting components 33 extends in a direction that is not the radial direction of the driven shaft 31 in this embodiment, each of the contact components 33 digs and moves effectively the workpiece 200 while contacting the workpiece 200 during the feeding process, and releases the workpiece 200 smoothly.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A feeding mechanism adapted for use with a woodworking machine, said feeding mechanism comprising:
a driving unit; and
a feeding roller unit including
a driven shaft that extends along a first axis from said driving unit, and that is driven by said driving unit to rotate about the first axis,
a feeding roller that is disposed co-rotatably around said driven shaft,
a plurality of contact components, each of which has a contact end portion and is resiliently movable relative to said feeding roller between an extended position, where said contact end portion is exposed from said feeding roller, and a retracted position, where said contact end portion is retracted into said feeding roller, and
a plurality of resilient components, each of which is disposed for biasing a respective one of said contact components toward the extended position.

2. The feeding mechanism as claimed in claim 1, wherein:
said driven shaft has opposite first and second ends along the first axis;
said feeding roller includes at least one roller plate unit having first and second roller plates that are respectively proximate to and distal from said first end of said driven shaft, each of said first and second roller plates having opposite first and second side surfaces along the first axis, said second side surface of said first roller plate being in contact with said first side surface of said second roller plate, each of said second side surface of said first roller plate and said first side surface of said second roller plate being formed with a plurality of angularly spaced apart grooves, each of said grooves in said second side surface of said first roller plate cooperating with a respective one of said grooves in said first side surface of said second roller plate to form a first receiving hole for confining movably a corresponding one of said contact components therein; and
each of said contact components in said first receiving holes further has an inner end portion disposed opposite to said contact end portion of a corresponding one of said contact components in said first receiving holes, and a flange portion disposed between said inner end portion and said contact end portion of the corresponding one of said contact components in said first receiving holes and permitting a corresponding one of said resilient components to abut resiliently thereagainst.

3. The feeding mechanism as claimed in claim 1, wherein each of said contact components extends along a second axis that is spaced apart from the first axis by a predetermined distance along an imaginary line passing through and perpendicular to the first and second axes.

4. The feeding mechanism as claimed in claim 3, wherein the second axis along which each of said contact components extends intersects a periphery of the corresponding one of said roller plate units of said feeding roller at an imaginary intersecting point, and forms an angle with an imaginary tangent line at the imaginary intersecting point.

5. The feeding mechanism as claimed in claim 2, wherein:
said feeding roller of said feeding roller unit includes a plurality of said roller plate units that are juxtaposed with each other along the first axis, said first side surface of said first roller plate of each of said roller plate units being formed with a plurality of angularly spaced apart grooves, said second side surface of said second roller plate of each of said roller plate units being formed with a plurality of angularly spaced apart grooves;
each of said grooves in said second side surface of said second roller plate of one of said roller plate units cooperates with a respective one of said grooves in said first side surface of said first roller plate of an adjacent one of said roller plate units to form a second receiving hole for confining movably a corresponding one of said contact components therein;
each of said contact components in said second receiving holes further has an inner end portion disposed opposite to said contact end portion of a corresponding one of said contact components in said second receiving holes, and a flange portion disposed between said inner end portion and said contact end portion of the corresponding one of said contact components in said second receiving holes and permitting a corresponding one of said resilient components to abut resiliently thereagainst; and
said first receiving holes in each of said roller plate units are staggered circumferentially relative to said second receiving holes.

6. The feeding mechanism as claimed in claim 5, wherein said feeding roller unit further includes a plurality of self-lubricating bushing units that are disposed respectively in said first and second receiving holes in each of said roller plate units, and that are sleeved respectively on said contact components.

7. The feeding mechanism as claimed in claim 1, further comprising a housing in which said feeding roller unit is disposed, said driving unit including a motor that is disposed on said housing, and a speed reduction gear unit that is disposed in said housing and that includes a driver component connected to said motor, a driven component, and first and second transmission components connected between said driver component and said driven component.

8. The feeding mechanism as claimed in claim 7, wherein:
said driver component of said speed reduction gear unit of said driving unit is a worm shaft;
said driven component of said speed reduction gear unit is a spur gear;
said first transmission component of said speed reduction gear unit includes a worm gear meshing with said driver component, and a spur gear co-rotatable with said worm gear; and
said second transmission component of said speed reduction gear unit is a dual-stepped gear member meshing with said driven component and said first transmission component.
